(19) United States
(12) Patent Application Publication
(10) Pub. No.: US 2010/0150801 A1
(43) Pub. Date: Jun. 17, 2010

(54) FORMED CATALYST FOR NOx REDUCTION

(75) Inventors: Hrishikesh Keshavan, Clifton Park, NY (US); Benjamin Hale Winkler, Albany, NY (US); Dan Hancu, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/711,432

(22) Filed: Feb. 24, 2010

Related U.S. Application Data
(63) Continuation-in-part of application No. 12/328,942, filed on Dec. 5, 2008.
Application No. 12/328,942 is a continuation-in-part of application No. 12/474,873, filed on May 29, 2009.
Application No. 12/474,873 is a continuation-in-part of application No. 12/173,492, filed on Jul. 15, 2008.
(60) Provisional application No. 60/994,448, filed on Sep. 19, 2007.

(51) Int. Cl. B01D 53/94; B01J 29/88; B01D 53/56

(52) U.S. Cl. 423/213.5; 502/66

(57) ABSTRACT

The present invention provides a formed catalyst comprising a binder, a zeolite, and a catalytic metal disposed on a porous inorganic material. The zeolite domains in the formed catalyst are substantially free of the catalytic metal which is disposed on and or within the porous inorganic material. The formed catalyst is in various embodiments an extrudate, a pellet, or a foamed material. In one embodiment, the catalytic metal is silver and the porous inorganic material is γ-alumina. The formed catalysts provided are useful in the reduction of NOx in combustion gas streams.

### CROSS REFERENCE TO RELATED APPLICATIONS

This application is a continuation-in-part of and claims the priority and benefit of U.S. patent application Ser. No. 12/328,942, filed Dec. 5, 2008 and entitled “MIXED CATALYST FOR NOx REDUCTION AND METHODS OF MANUFACTURE THEREOF” which is incorporated herein by reference in its entirety and U.S. patent application Ser. No. 12/474,873, filed May 29, 2009 which application is a continuation-in-part of U.S. patent application Ser. No. 12/173,492, filed Jul. 15, 2008 and entitled “CATALYST AND METHOD OF MANUFACTURE” which claims the priority and benefit of U.S. Provisional Application No. 60/994,448, filed on Sep. 19, 2007, each of which is incorporated in its entirety herein by reference.

### FIELD OF THE INVENTION

The invention includes embodiments that relate to a catalyst composition. The invention also includes embodiments that relate to a method of making and/or using the catalyst composition.

### BACKGROUND OF THE INVENTION

Regulations continue to evolve regarding the reduction of oxide gases of nitrogen (NOx) for diesel engines in trucks and locomotives. NOx gases may be undesirable. A NOx reduction solution may include treating diesel engine exhaust with a catalyst that can reduce NOx to N₂ and O₂ using a reductant. This process may be referred to as selective catalytic reduction or “SCR”.

In selective catalytic reduction (SCR), a reductant, such as ammonia, is injected into the exhaust gas stream to react with NOx in contact with a catalyst. When ammonia is used, reduction products include nitrogen and water. Three types of catalysts are commonly used in these systems. The types include base metal systems, and zeolite systems. Base metal catalysts operate in the intermediate temperature range (310° C. to 400° C.), but at high temperatures they may promote oxidation of SO₂ to SO₃. These base metal catalysts may include vanadium pentoxide and titanium dioxide. The zeolites may withstand temperatures up to 600° C. and, when impregnated with a base metal, have a wide range of operating temperatures.

Hydrocarbons may also be used in the selective catalytic reduction of NOx emissions. NOx can be selectively reduced by a variety of organic compounds (e.g. alkanes, olefins, alcohols) over several catalysts in the presence of excess O₂. The injection of diesel fuel or methanol has been explored in heavy-duty stationary diesel engines to supplement the hydrocarbon in the exhaust stream. However, the conversion efficiency may be reduced outside the narrow temperature range of 300° C. to 500° C. In addition, there may be other undesirable consequences.

A selective catalytic reduction catalyst may include catalytic metals disposed upon a porous substrate. However, these catalysts often do not function properly when NOx reduction is desired. In addition, catalyst preparation and deposition on a substrate may be involved and complex. As a result, the structure and/or efficacy of the catalyst may be compromised during manufacture. It is therefore desirable to have catalysts that can effect NOx reduction across a wide range of temperatures and operating conditions. It is also desirable if the method and apparatus can be implemented on existing engines and do not require large inventories of chemicals. It is further desirable to have a method of making such catalysts that does not require washcoating a substrate, whereby the processing steps do not compromise the catalyst activity.

### BRIEF SUMMARY OF THE INVENTION

In one embodiment, the present invention provides a formed catalyst comprising a binder; and a zeolite; and a catalytic metal disposed upon a porous inorganic material; wherein the zeolite is substantially free of the catalytic metal, and wherein the formed catalyst is configured as an extrudate, pellet or foam.

In another embodiment, the present invention provides a method of making a formed catalyst, comprising combining a binder, a first catalyst composition comprising a zeolite, and a second catalyst composition comprising a catalytic metal disposed upon a porous inorganic material, to form an extrudable mixture wherein said zeolite is substantially free of the catalytic metal; and extruding said mixture to provide a formed catalyst configured as an extrudate.

In yet another embodiment, the present invention provides a method of making a formed catalyst, comprising combining a binder, a first catalyst composition comprising a zeolite, and a second catalyst composition comprising a catalytic metal disposed upon a porous inorganic material, and a solvent to form a slurry; immersing a template in the slurry; removing the template from the slurry to provide a treated template; and calcining the treated template to provide a formed catalyst configured as a foam.

In yet another embodiment, the present invention provides a method of reducing NOx, the method comprising exposing an exhaust gas stream comprising NOx to a formed catalyst, the formed catalyst comprising a zeolite and a catalytic metal disposed upon a porous inorganic material; wherein the zeolite is substantially free of the catalytic metal, and wherein the formed catalyst is configured as an extrudate, pellet or foam.

### DETAILED DESCRIPTION OF THE INVENTION

The invention includes embodiments that relate to a foam or extrudate catalyst. The catalyst is effective for reducing NOx present in emissions generated during combustion in furnaces, ovens, and engines.

As used herein, without further qualifiers a “catalyst” is a substance that can cause a change in the rate of a chemical reaction without itself being consumed in the reaction. A “slurry” is a mixture of a liquid and finely divided particles. A “powder” is a substance including finely dispersed solid particles. As used herein, the term “calcination” is a process in which a material is heated to a temperature below its melting point to effect a thermal decomposition or a phase transition other than melting.

As noted, in one embodiment, the formed catalyst provided by the present invention comprises a binder, a zeolite and a catalytic metal disposed upon a porous inorganic material; wherein the zeolite is substantially free of the catalytic metal, and wherein the formed catalyst is configured as an extrudate, pellet or foam.

The formed catalyst may be used to reduce NOx present in an emissions stream. In certain embodiments, the zeolite is considered to be part of a first catalyst composition, and the catalytic metal disposed upon a porous inorganic material is considered to be part of a second catalyst composition, and the formed catalyst can be thought of as a mixture of the first catalyst composition and the second catalyst composition.

The porous inorganic material may be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or the like, or a combination comprising at least one of the foregoing inorganic materials. The porous inorganic material is not, however, a zeolite.

When the formed catalyst is employed to reduce NOx generated in for example combustion emissions from furnaces, ovens or engines, a variety of organic compounds may be employed as the stoichiometric reductant. The stoichiometric reductant is mediated by the formed catalyst, without which the stoichiometric reductant would be largely ineffective in NOx reduction. The stoichiometric reductant is at times herein referred to as the organic reductant and is typically a hydrocarbon such as propylene, a mixture of organic compounds such as diesel fuel, or an aliphatic alcohol such as ethanol. Hydrocarbons can be effectively used as the stoichiometric reductant. in one embodiment, hydrocarbons having from about 5 to about 9 carbon atoms are used as the stoichiometric reductant. The catalyst advantageously functions well across a wide temperature range, especially at temperatures from about 325° C. to about 400° C.

The formed catalyst comprises a zeolite. The zeolite may be naturally occurring or synthetic, and may be in the form of a powder. Examples of suitable zeolites are zeolite Y, zeolite beta, ferrierite, mordenite, zeolite ZSM-5, or a combination comprising at least one of the foregoing zeolites. Zeolite ZSM-5 is commercially available from Zeolyst International (Valley Forge, Pa.). In one embodiment, the zeolite is a ferrierite having a silicon to aluminum ratio of about 20.

Examples of commercially available zeolites that may be used in the formed catalysts provided by the present invention are marketed under the following trademarks: CBV100, CBV300, CBV400, CBV500, CBV600, CBV712, CBV720, CBV760, CBV780, CBV901, CP814E, CP814C, CP811C-300, CP914, CP914C, CBV2314, CBV3024E, CBV5524G, CBV8014, CBV28014, CBV10A, CBV21A, CBV90A. The foregoing zeolites are available from Zeolyst International, and may be used individually or in a combination comprising two or more of the zeolites.

In one embodiment, the zeolite particles used in the preparation of the formed catalyst may have an average particle size of less than about 50 micrometers.

In one embodiment, the zeolite particles have an average particle size of about 50 micrometers to about 400 micrometers. In one embodiment, the zeolite particles have an average particle size of about 400 micrometers to about 800 micrometers. In another embodiment, the zeolite particles have an average particle size of about 800 micrometers to about 1600 micrometers.

In one embodiment, the zeolite particles may have a surface area of about 200 m²/gm to about 300 m²/gm. In an alternate embodiment, the zeolite particles may have a surface area of about 300 m²/gm to about 400 m²/gm. In yet another embodiment, the zeolite particles have a surface area of about 400 m²/gm to about 500 m²/gm. In yet another embodiment, the zeolite particles have a surface area of about 500 m²/gm to about 600 m²/gm.

Prior to combining the zeolite with the catalytic metal disposed upon a porous inorganic material, the zeolite may be calcined to produce the H form of the zeolite, which has been found to be advantageous. The H form of the zeolite is the protonic form of the zeolite. Commercially available zeolites are typically obtained in the NH₄ form. During calcination, NH₃ is released to create the H form of the zeolite. In one embodiment, the zeolite does not comprise any of the catalytic metal. It is important that the zeolite remains in the H form during preparation of the formed catalyst to inhibit migration of the catalytic metal from the porous inorganic material into the zeolite, during, for example, a process step involving calcination. As is demonstrated in the experimental section of this disclosure the catalytic metal is less effective when it is distributed both in the porous inorganic material and in the zeolite.

The parameters and conditions used for zeolite calcination may depend on the type of zeolite used. In one embodiment, the zeolite is calcined at a temperature in a range from about 100° C. to about 300° C. In one embodiment, the zeolite is calcined at a temperature in a range from about 300° C. to about 600° C. In another embodiment, the zeolite is calcined in air at a temperature in a range from about 600° C. to about 900° C. In yet another embodiment, the zeolite is calcined in N₂ at 100° C. for 1 hr, at 550° C. for 1 hr, and then in air at 550° C. for 5 hrs. Alternatively, the zeolite can be calcined in air at 550° C. for 4 hrs with a very slow ramp rate such as 1 degree Celsius per minute in a dry air feed. The zeolite can also be calcined under vacuum in order to avoid alteration of the zeolite cage structure.

Desirably, the zeolite is present in the formed catalyst in an amount corresponding to from about 1 to about 40 weight percent, based on the total weight of the formed catalyst. In another embodiment, the zeolite is present in the formed catalyst in an amount corresponding to from about 1 weight percent to about 20 weight percent, based on the total weight of the formed catalyst. In yet another embodiment, the zeolite is present in the formed catalyst in an amount corresponding to from about 1 weight percent to about 10 weight percent, based on the total weight of the formed catalyst. In one embodiment, the zeolite is present in an amount corresponding to from about 1 weight percent to about 5 weight percent, based upon the total weight of the formed catalyst.

As noted above, the formed catalyst provided by the present invention comprises a catalytic metal disposed upon a porous inorganic material. The porous inorganic materials are metal oxides, inorganic oxides, inorganic carbides, inorganic nitrides, inorganic hydroxides, inorganic oxides having a hydroxide coating, inorganic carbonitrides, inorganic oxynitrides, inorganic borides, inorganic borocarbides, or a combination comprising at least one of the foregoing inorganic materials. As noted, the porous inorganic material is not a zeolite. In one embodiment, the porous inorganic material is selected from the group consisting of inorganic oxides, inorganic carbides, inorganic nitrides, inorganic hydroxides, inorganic oxides having a hydroxide coating, inorganic carbonitrides, inorganic oxynitrides, inorganic borides, inorganic borocarbides, and combinations comprising at least one of the foregoing inorganic materials.

Examples of suitable inorganic oxides useful as the porous inorganic material include silica (SiO₂), alumina (Al₂O₃), titania (TiO₂), zirconia (ZrO₂), ceria (CeO₂), manganese oxide (MnO₂), zinc oxide (ZnO), iron oxides (e.g., FeO, β-Fe₂O₃, γ-Fe₂O₃, ε-Fe₂O₃, Fe₃O₄, and the like), calcium oxide (CaO), manganese other than manganese dioxide, and combinations comprising at least one of the foregoing inorganic oxides. Examples of inorganic carbides useful as the porous inorganic material include silicon carbide (SiC), titanium carbide (TiC), tantalum carbide (TaC), tungsten carbide (WC), hafnium carbide (HfC), and the like, and combinations comprising at least one of the foregoing carbides. Examples of suitable nitrides useful as the porous inorganic material include silicon nitrides, titanium nitride, and the like, and combinations comprising at least one of the foregoing. Examples of suitable borides useful as the porous inorganic material are lanthanum boride, chromium borides, molybdenum borides, tungsten boride, and the like, and combinations comprising at least one of the foregoing borides. In one embodiment, the porous inorganic material is alumina. In one embodiment, the porous inorganic material is selected from the group consisting of silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, and combinations comprising at least one of the foregoing.

In various embodiments, the porous inorganic material may have a surface area of from about 100 m²/g to about 200 m²/gm, from about 200 m²/g to about 300 m²/gm, from about 300 m²/g to about 400 m²/gm, from about 400 m²/g to about 500 m²/gm, from about 500 m²/g to about 600 m²/gm, from about 600 m²/g to about 700 m²/gm, from about 700 m²/g to about 800 m²/gm, from about 800 m²/g to about 1000 m²/gm, from about 1000 m²/g to about 1200 m²/gm, from about 1200 m²/g to about 1300 m²/gm, from about 1300 m²/g to about 1400 m²/gm, from about 1400 m²/g to about 1500 m²/gm, from about 1500 m²/g to about 1600 m²/gm, from about 1600 m²/g to about 1700 m²/gm, from about 1700 m²/g to about 1800 m²/gm, or from about 1800 m²/g to about 2000 m²/gm. In an exemplary embodiment, the porous inorganic material has a surface area in a range of from about 200 m²/g to about 500 m²/g.

The porous inorganic material may be in the form of particles prior to its incorporation into the formed catalyst. In one embodiment, the porous inorganic material is employed as a powder.

The porous inorganic material employed typically has an average particle size of about 0.2 micrometers to about 5 micrometers. In one embodiment, the porous inorganic material employed in the preparation of the formed catalyst has an average particle size of from about 5 micrometers to about 25 micrometers. In another embodiment, the porous inorganic material has an average particle size of from about 25 micrometers to about 50 micrometers. In another embodiment, the porous inorganic material has an average particle size of from about 50 micrometers to about 75 micrometers. In another embodiment, the porous inorganic material has an average particle size of from about 75 micrometers to about 100 micrometers. In an exemplary embodiment, the porous inorganic material has an average particle size of about 40 micrometers.

As noted, the formed catalyst comprises a catalytic metal disposed upon the porous inorganic material. This includes embodiments wherein the catalytic metal is disposed on the surface of a particle of the porous inorganic material, and also includes embodiments where the catalytic metal is disposed within a particle of the porous inorganic material. In one embodiment, the catalytic metal is disposed upon particles of a porous inorganic material such that the catalytic metal may be found both on the surface of particles of the porous inorganic material and within the interior of particles of the porous inorganic material. The catalytic metal may be a single metal species or a mixture of metal species, the only requirement being that the catalytic metal catalyze the conversion of NOx into one or more NOx reduction products, such as nitrogen. In one embodiment, the catalytic metal comprises one or more metals selected from alkali metals, alkaline earth metals, transition metals, and main group metals. Examples of suitable catalytic metals are silver, platinum, gold, palladium, iron, nickel, cobalt, gallium, indium, ruthenium, rhodium, osmium, iridium, and the like, and a combination comprising at least two of the foregoing metals. In one embodiment, the catalytic metal is silver. In one embodiment, the catalytic metal is selected from among the noble metals. In another embodiment, the catalytic metal is a transition metal. In another embodiment, the catalytic metal is a metal in the lanthanide series such as cerium and samarium. In one embodiment, the catalytic metal is gold, palladium, cobalt, nickel, iron, gallium, indium, zirconium, copper, zinc or a combination comprising at least one of the foregoing metals.

The catalytic metal may be present in the formed catalyst provided by the present invention as a uniform distribution throughout the porous inorganic material. Alternatively, the catalytic metal may be present in the formed catalyst provided by the present invention as metal particles disposed on the surface, the interior or throughout the porous inorganic material. In one embodiment, the average catalytic metal particle size is about 0.1 nanometer to about 500 nanometers. The catalytic metal is typically present in an amount corresponding to from about 0.025 mole percent (mol %) to about 5 mol % based on a total number of moles of the porous inorganic material. In one embodiment, the catalytic metal is present in an amount corresponding to from about 5 mol % to about 20 mol % based on a total number of moles of the porous inorganic material. In another embodiment, the catalytic metal is present in an amount corresponding to from about 20 mol % to about 30 mol % based on a total number of moles of the porous inorganic material. In yet another embodiment, the catalytic metal is present in an amount corresponding to from about 30 mol % to about 40 mol % based on a total number of moles of the porous inorganic material. In yet another embodiment, catalytic metal is present in an amount corresponding to from about 40 mol % to about 50 mol % based on a total number of moles of the porous inorganic material.

The zeolite and the porous inorganic material on which is disposed the catalytic metal are typically prepared as powders which may be used to prepare the formed catalyst provided by the present invention. In one embodiment, prior to combining the zeolite with the porous inorganic material on which is disposed the catalytic metal, the zeolite and/or the porous inorganic material comprising the catalytic metal may be milled or pulverized to reduce their particle sizes to the desired ranges disclosed herein. In one embodiment, the porous inorganic material is first milled and subsequently the catalytic metal is disposed upon it. Suitable milling methods include ball milling, ultrasonic milling, planetary milling, jet milling, and combinations thereof. In one embodiment, the zeolite and the porous inorganic material comprising a catalytic metal are ball milled before being incorporated into the formed catalyst.

The porous inorganic material comprising a catalytic metal may be prepared as follows and as disclosed in the experimental section of this invention. The catalytic metal and the porous inorganic material are combined with a solvent to form a slurry. Suitable solvents for forming the slurry include water, alcohols such as short chain alcohols, polar protic solvents and polar aprotic solvents. The slurry is then milled using one or more of the techniques described hereinabove. The slurry may then be dried by, for example, spray drying, freeze-drying, or super-critical drying. The composition comprising the catalytic metal and the porous inorganic material is then subjected to calcination to form a calcined powder comprising the catalytic metal. This calcined powder may be used to prepare the formed catalyst provided by the present invention.

Calcination conditions may vary according to the porous inorganic material and catalytic metal employed. In one embodiment, calcination is carried out in air at a temperature in a range from about 100° C. to about 400° C. In another embodiment, calcination is carried out in air at a temperature in a range from about 400° C. to about 800° C. In yet another embodiment, calcination is carried out in air at a temperature in a range from about 800° C. to about 1100° C.

As noted, the formed catalyst provided by the present invention comprises a porous inorganic material upon which is disposed a catalytic metal. In one embodiment, the porous inorganic material is present in an amount corresponding to from about 60 weight percent to about 99 weight percent, based upon the total weight of the formed catalyst. In another embodiment, the porous inorganic material is present in an amount corresponding to from about 80 weight percent to about 99 weight percent, based upon the total weight of the formed catalyst. In yet another embodiment, the porous inorganic material is present in an amount corresponding to from about 90 weight percent to about 99 weight percent, based upon the total weight of the formed catalyst. In an exemplary embodiment, the porous inorganic material is present in an amount corresponding to from about 90 weight percent to about 95 weight percent, based upon the total weight of the formed catalyst.

The formed catalysts provided by the present invention may include a binder to aid in creating structures having a desired shape and/or dimensions. Examples of suitable binders include permanent binders and temporary binders. The binders may be organic or inorganic binders. A permanent binder comprises part of the formed catalyst and is not removed. An example of a permanent binder is boehmite. Temporary binders are usually organic and are added to aid in the preparation of the formed catalyst, for example to aid in extrusion and/or foam formation. Temporary binders are typically removed from the formed catalyst upon calcination of the formed catalyst. Examples of temporary binders include synthetic polymers, saw dust, methylcellulose-type binders, molasses, and sugar.

The binder may be combined with either or both of the zeolite and the porous inorganic material on which is disposed the catalytic metal to form an intermediate catalyst composition. In one embodiment, the zeolite and the porous inorganic material comprising the catalytic metal are first combined to form a solid mixture, and the binder is added to this mixture to form an intermediate catalyst composition.

In one embodiment, the intermediate catalytic composition is formed into an extrudate using any method known to those skilled in the art. In one embodiment an extrusion mull is prepared and then extruded. The extrusion mull may be prepared by mixing the components of the formed catalyst until a homogenous mull is formed. A high-speed planetary mixer may be used to form the extrusion mull. The mull is then passed through an extruder such as a BB Gun extruder, available from The Bonnot Company, Uniontown, Ohio.

In one embodiment, the formed catalyst is an extrudate having a thickness in a range of from about 1.0 mm to about 4.0 mm. In one embodiment, the extrudate has a thickness in a range of from about 4.0 mm to about 7.0 mm. In another embodiment, the extrudate has a thickness in a range of from about 7.0 mm to about 9.0 mm. In yet another embodiment, the extrudate has a thickness in a range of from about 9.0 mm to about 12 mm. In one embodiment, the formed catalyst is configured as an extrudate having a thickness in a range from about 1.0 mm to about 12 mm.

In certain embodiments, following the extruding process, the extrudate is dried. The extrudate may be dried at a temperature in a range of from about 25° C. to about 40° C., from about 40° C. to about 80° C., or from about 80° C. to about 110° C. In one embodiment, the extrudate is dried in a box oven at a temperature of 80° C. for approximately 6 hours.

The extrudate is then calcined at a temperature in a range of from about 400° C. to about 500° C. In another embodiment, the extrudate is calcined at a temperature in a range from about 500° C. to about 600° C. In yet another embodiment, the extrudate is calcined at a temperature in a range from about 600° C. to about 800° C.

In an alternative embodiment, the formed catalyst provided by the present invention is prepared from an intermediate catalytic composition comprising a foaming agent. The intermediate catalytic composition may be converted into a foam using a variety of methods known to those of ordinary skill in the art. For example, a foam may be produced by a process comprising gel casting the intermediate catalytic composition.

Any suitable foaming agent may be used in the intermediate catalytic composition. For example, the foaming agent may be an organic solvent that foams under heat or via a chemical reaction. Suitable organic solvents include, but are not limited to Hypol®, a hydrophilic polyurethane prepolymer available from Dow Chemical Company. Alternatively, the foaming agent may be a template, such as a polyurethane foam or a cellulose foam.

If a template is utilized, a slurry is prepared comprising a solvent, the binder, the zeolite and the porous inorganic material on which is disposed the catalytic metal. Suitable solvents include water, alcohols such as short chain alcohols, polar protic solvents and polar aprotic solvents. Suitable short chain alcohols are exemplified by methanol, ethanol, isopropanol, butanol, ethylene glycol, and propylene glycol. Suitable polar protic solvents are exemplified by acetic acid, trifluoroethanol, propionic acid, and trifluoroacetic acid. Suitable polar aprotic solvents are exemplified by dimethylformamide (DMF), N-methylpyrrolidinone (NMP), dimethylsulfoxide (DMSO), tetrahydrofuran (THF), and ethylene glycol dimethyl ether (EGDME). The template may be immersed in the slurry to bring the template into contact with the slurry components. The template is then removed from the slurry to afford a treated template (i.e. a template impregnated with the slurry components). Excess slurry may be removed from the treated template and then the treated template may be calcined to provide a formed catalyst configured as a foam.

In one embodiment, the treated template is calcined at a temperature in a range from about 200° C. to about 500° C. In an alternate embodiment, the treated template is calcined in a range from about 500° C. to about 800° C. In yet another embodiment, the treated template is calcined in a range from about 800° C. to about 1100° C. In various embodiments, the calcining step removes the template by burning it away from the other components of the formed catalyst which are not subject to being burnt away, for example the zeolite, the porous inorganic material on which catalytic metal is disposed, inorganic binders and other relatively stable components which may be present. The template may be selected such that it is removed under relatively mild calcination conditions under which more robust organic binders survive. Calcining temperatures may be selected based upon TGA-DTA analysis of the treated template. In one embodiment, the treated template is held for a period ranging from several minutes to several hours at a temperature just below decomposition temperature of the template material. The temperature can then be increased and the calcination time adjusted so that all of, or only a portion of the template material is removed. In one embodiment, the reaction products from the decomposition of the template material act as a binder for the formed catalyst.

In one embodiment, the formed catalyst provided by the present invention is disposed in the exhaust stream of an internal combustion engine. The internal combustion engine can be present in, for example, an automobile or in a locomotive.

In certain embodiments, the formed catalyst reduces NOx to nitrogen at rates that are superior to conventional catalysts. In certain other embodiments, the formed catalyst provided by the present invention enables operating enhancements over conventional catalysts.

In certain embodiments, the zeolite is considered to be part of a first catalyst composition, and the catalytic metal disposed upon a porous inorganic material is considered to be part of a second catalyst composition, and the formed catalyst can be thought of as a mixture of the first catalyst composition and the second catalyst composition. Thus, in one embodiment, the present invention provides a formed catalyst comprising a binder and a catalytic composition. The catalytic composition comprises a first catalyst composition that comprises a zeolite, and a second catalyst composition that comprises a catalytic metal disposed upon a porous inorganic material. The porous inorganic material is typically a metal oxide, and is not itself a zeolite. In one embodiment, the porous inorganic material is an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials. In one embodiment, the formed catalyst provided by the present invention is configured as an extrudate. In an alternate embodiment, the in the formed catalyst provided by the present invention is configured as a foam. In yet another embodiment, the formed catalyst provided by the present invention is configured as a pellet.

In an alternate embodiment, the present invention provides a method of making a formed catalyst, comprising combining a first catalyst composition, a second catalyst composition, and a binder to form an intermediate catalytic composition; the first catalyst composition comprising a zeolite; the second catalyst composition comprising a catalytic metal disposed upon a porous inorganic material, and then forming a formed catalyst from the intermediate catalytic composition.

In yet another embodiment, the present invention provides a method of reducing NOx comprising exposing an exhaust gas stream comprising NOx to a formed catalyst. The formed catalyst comprises a binder and a catalytic composition, the catalytic composition comprising a first catalyst composition that comprises a zeolite, and a second catalyst composition that comprises a catalytic metal disposed upon a porous inorganic material.

The following examples, which are meant to be exemplary, not limiting, illustrate compositions and methods of making some of the various embodiments of the catalysts described herein.

### EXAMPLES, COMPARATIVE EXAMPLES AND EXPERIMENTAL PROTOCOLS

Protocol 1—Preparation of Silver on Alumina (Also Referred to Herein as the Second Catalyst Composition)

γ-Al₂O₃ can be obtained commercially from various sources including UOP LLC, Des Plaines, Ill. AgNO₃, ethanol and high purity ZrO₂ media (milling balls) are added to the γ-Al₂O₃ to form a slurry indicated in Table 1. The slurry is ball milled for 24 hours and dried at 80° C. for 8 hours. The fine powder is calcined in air slowly to 600° C. to form Ag—Al₂O₃.

TABLE 1
Slurry preparation for Ag—Al₂O₃

| Alumina (g) | AgNO₃ (g) | Ethanol (g) | ZrO₂ (g) | Mill time (h) |
|---|---|---|---|---|
| 50 | 2.435 | 50.00 | 100 | 24 |

Protocol 2—Preparation of Second Catalyst Composition

A slurry is prepared by combining 30 g of γ-Al₂O₃, 70 g of water, and 250 g of high purity ZrO₂ media (milling balls). HNO₃ is added to the slurry to adjust the pH of the slurry to between 3.5 and 4.5. The slurry is ball milled for 24 hours, and 2.3 g of AgNO₃ is added to the slurry and the slurry is ball milled for an additional 30 minutes, and then freeze dried in a Mill Rock freeze dryer at reduced pressure (300 mTorr). The freeze drying cycle is shown in Table 2 below.

TABLE 2
Freeze Drying Cycle

| Temp (° C.) | Time (min) |
|---|---|
| −55 | 240 |
| −50 | 240 |
| −45 | 240 |
| −40 | 240 |
| −35 | 240 |
| −30 | 240 |
| −25 | 240 |
| −20 | 240 |
| −15 | 240 |
| −10 | 240 |
| −5 | 240 |
| 0 | 240 |
| 5 | 240 |
| 10 | 240 |
| 15 | 240 |
| 20 | 240 |
| 25 | 240 |
| 30 | 240 |
| 35 | 240 |
| 40 | 240 |

Protocol 3—Zeolite Treatment

Ferrierite zeolite CP914C obtained from Zeolyst International, Valley Forge, Pa. was calcined in order to convert the ferrierite to its H form. The ferrierite powder is calcined in N₂ at 110° C. for 1 hr, at 550° C. for 1 hr, and then in air at 550° C. for 1 hr.

### Example 1

### Preparation of Formed Catalyst Extrudate

The Ag—Al₂O₃ powder prepared in Protocol 1 and the ferrierite zeolite powder prepared in Protocol 3 are combined in a weight ratio of 4:1. The powders along with 20% inorganic binder VERSAL V-250 (pseudoboehmite) are mixed together with a high speed planetary mixer. The powders are mixed in multiple cycles at 2000 rpm for 30 seconds, until a homogenous mull is formed. The addition of the inorganic binder allows control of the rheology of the resulting mixture and facilitates extrusion. No organic binder or lubricant was used during the preparation of the mull. The mull is extruded in a BB Gun extruder with an auger speed of 5 rpm at 1000 psi to form short lengths of extrudate having a thickness of 1/16 inch. The extrudates are dried in an oven at 80° C. for 4 hrs, and then calcined at 600° C. for 4 hrs in dry air with a molecular sieve oil filter to trap any organics in the air feed.

### Example 2

### Preparation of Catalyst Foam

The Ag—Al₂O₃ powder prepared in Protocol 1 and the ferrierite zeolite powder prepared in Protocol 3 are combined in a weight ratio of 4:1. Water is added to the powder mixture to form a slurry. A polyurethane foam template is immersed in the slurry until thoroughly soaked. The treated template is then removed from the slurry and excess slurry is removed from the treated template by gently squeezing the treated template. The treated template is dried at 100° C. for 3 hours, and then calcined as indicated in Table 3. The dwell time is the period of time the treated template is kept at a specific temperature, i.e. the isothermal hold time.

TABLE 3
Calcination Cycle for Catalyst Foam

| Atmosphere | Ramp Rate | Temp (° C.) | Dwell time (hr) |
|---|---|---|---|
| Nitrogen | 1 | 125 | 2 |
| Nitrogen | 1 | 250 | 10 |
| Nitrogen | 1 | 550 | 4 |
| Air | — | 550 | 5 |
| Air | 1 | 25 | — |

### Examples 3-4 and Comparative Examples 1-2

The following experiments illustrate the importance to catalyst performance of disposing the metal catalyst on the porous inorganic material and not on the zeolite. The catalyst composition of the Examples was an intimate mixture of CP914 zeolite, and silver disposed on alumina and wherein the zeolite is substantially free of silver. The catalyst composition of the Comparative Examples was an intimate mixture of an equivalent amount of silver disposed on both the CP914 zeolite and alumina prepared by exposing a mixture of alumina and the zeolite to a solution of silver nitrate, isolating the resultant solid and calcining it to provide the catalyst. The zeolite of this Comparative Examples contains a substantial amount of the silver catalytic metal.

Thus, 9.455 grams of NH4-Ferrierite (CP914C, Zeolyst International, Conshohocken, Pa.) was combined with 17.56 g of deionized water in a 125 mL NALGENE HDPE container. The slurry was mixed on a roll mill for 1 hour before drying in a PTFE dish in an infrared oven for 12 hour. The dried-powder was calcined at 550° C. using a 1° C./min ramp up rate for 4 hour. The ramp down rate was 5° C./min. The calcination was carried out in a box furnace under an atmosphere of air to afford the hydrogen (H form) of the zeolite. The calcined zeolite powder was sieved using a 25-40 mesh sieves. The fraction of zeolite powder collected between the sieves was used for further testing.

VERSAL V-250 (46 grams, UOP Catalysts, Baton Rouge, La.) was calcined at 550° C. to afford 34.53 grams of γ-Al₂O₃ which was cooled to room temperature and combined with 65 grams of deionized water in a plastic container. The pH of the slurry was adjusted to 4.5 with concentrated nitric acid. 340 g of 6 mm high purity YTZ (ZrO₂) media (TOSOH, Japan) was added, the container was sealed and placed on a roll mill for 24 hours to pulverize the powder. 1.68 g of AgNO3 was to the resultant slurry and milling was continued for an additional 1 hour. The slurry was poured into a PTFE dish and dried in an infrared oven for 12 hour. The dried-powder was calcined as described above. The resultant calcined powder was sieved using a 25-40 mesh sieves. The fraction of silver on alumina powder collected between the sieves was used for further testing.

The sieved silver on alumina powder (10 grams) was thoroughly mixed with 2.5 grams of the sieved zeolite (2.5 grams) to provide the catalyst used in embodiments of the present invention in which the zeolite component is substantially free of silver.

The catalyst used in the Comparative Examples was prepared as follows. VERSAL V-250 (46 grams, UOP Catalysts, Baton Rouge, La.) was calcined at 550° C. to afford 34.53 grams of γ-Al₂O₃ which was cooled to room temperature and combined with 65 grams of deionized water in a plastic container. NH4-Ferrierite (9.455 grams) and γ-Al₂O₃ (34.53 grams) prepared above were added to deionized water (95.95 grams) in a 250 mL NALGENE HDPE container. The pH of the slurry was adjusted to 4.5 with concentrated nitric acid. 340 grams of 6 mm high purity YTZ (ZrO2) media (TOSOH, Japan) was added and the slurry was roll milled for 24 hours to pulverize the powder. Silver nitrate (1.68 g AgNO₃) was then added to the slurry and the resultant slurry was roll milled for an additional 1 hour. The slurry was poured in a PTFE dish and dried in an infrared oven for 12 hour. The dried-powder was calcined at 550° C. as described above. The calcined powder was sieved using a 25-40 mesh sieves. The fraction of powder collected between the sieves was used as the catalyst in Comparative Examples 1 and 2.

In each of the Examples 3-4 and the Comparative Examples 1-2, the catalyst (2.5 grams) was charged to a flow reactor configured to be heated while a test gas stream was allowed to flow through the catalyst sample. A DOC (Diesel oxidation catalyst, Pt/Al2O3, catalyst beads) was inserted downstream of the experimental catalyst to oxidize any secondary emissions formed on the experimental catalyst. The temperature of the DOC catalyst was kept constant at 550° C. The test gas stream contained 1800 (on a C1 basis) parts per million propylene, 300 ppm NO, 7% by volume water, 9% by volume oxygen (O₂), the balance being nitrogen (N₂). Total flow of the test gas stream was 3 standard liters per minute (SLPM).

The reactor was first equilibrated at 450° C. The test gas mixture was formed by injection of a mixture of propylene in nitrogen into a stream containing the other components (nitrous oxide, water, oxygen, and nitrogen) to reach the target reductant dosage of 1800 ppm propylene (on a C1 basis) and a ratio of propylene to nitrous oxide of about 6 (“C1”:NO=6, where the “C1:NO ratio” represents moles of carbon atoms from the organic reductant per mole of NO molecules in the gas stream.) The catalyst was tested at approximately 450° C., 400° C., 350° C. and 300° C. for 1 hour at each temperature each. Then, the propylene injection was stopped, and the catalyst was brought back to 450° C. The test was repeated with an equivalent amount of ULSD (diesel fuel) as the organic reductant at a concentration of 1700-1800 ppm (on a C1 basis) in an equivalent test gas stream containing 300 ppm NO, 7% by volume water, 9% by volume oxygen (O₂), the balance being nitrogen (N₂). Total flow of the test gas stream was 3 SLPM.

TABLE 4
Example 3 and Comparative Example 1

| | Catalyst and Feed | Organic | Temp. | NO to N₂ |
|---|---|---|---|---|
| Entry | Stream (C:N Ratio) | reductant | ° C. | Conversion |
| Example 3 | zeolite and silver on | propylene | 308° C. | 69% |
| | Al₂O₃ only (5.32) | | | |
| Example 3 | zeolite and silver on | propylene | 355° C. | 68% |
| | Al₂O₃ only(5.32) | | | |
| Example 3 | zeolite and silver on | propylene | 400° C. | 64% |
| | Al₂O₃ only(5.38) | | | |
| Example 3 | zeolite and silver on | propylene | 450° C. | 51.4% |
| | Al₂O₃ only(5.32) | | | |
| Comparative | silver on zeolite and | propylene | 308° C. | 35.6% |
| Example 1 | Al₂O₃ (5.30) | | | |
| Comparative | silver on zeolite and | propylene | 355° C. | 39.4% |
| Example 1 | Al₂O₃ (5.33) | | | |
| Comparative | silver on zeolite and | propylene | 400° C. | 61.9% |
| Example 1 | Al₂O₃ (5.33) | | | |
| Comparative | silver on zeolite and | propylene | 450° C. | 51.3% |
| Example 1 | Al₂O₃ (5.38) | | | |

TABLE 5
Example 4 and Comparative Example 2

| | | Organic | Temp. | NO to N₂ |
|---|---|---|---|---|
| Entry | Catalyst | reductant | ° C. | Conversion |
| Example 4 | zeolite and silver on | ULSD | 307° C. | 50% |
| | Al₂O₃ only (5.47) | | | |
| Example 4 | zeolite and silver on | ULSD | 353° C. | 62.4% |
| | Al₂O₃ only (5.67) | | | |
| Example 4 | zeolite and silver on | ULSD | 399° C. | 58.1% |
| | Al₂O₃ only (5.87) | | | |
| Example 4 | zeolite and silver on | ULSD | 449° C. | 58% |
| | Al₂O₃ only (6.12) | | | |
| Comparative | silver on zeolite and | ULSD | 307° C. | 14.7% |
| Example 2 | Al₂O₃ (5.29) | | | |
| Comparative | silver on zeolite and | ULSD | 353° C. | 33.7% |
| Example 2 | Al₂O₃ (5.12) | | | |
| Comparative | silver on zeolite and | ULSD | 399° C. | 45.3% |
| Example 2 | Al₂O₃ (5.62) | | | |
| Comparative | silver on zeolite and | ULSD | 449° C. | 49.8% |
| Example 2 | Al₂O₃(6.13) | | | |

The data presented in Tables 4 and 5 show clearly the benefits of incorporating the catalytic metal (silver) on the porous inorganic material (Al₂O₃), compared with distributing the catalytic metal over both the zeolite and the porous inorganic material.

### Example 5

### Catalytic Performance of Extruded Catalyst with Ethanol as the Organic Reductant

An extruded catalyst comprising silver on alumina (Al₂O₃) as an intimate mixture with the ferrierite zeolite powder prepared as in Protocol 3, the ferrierite being substantially free of silver in the extruded catalyst, was prepared as in Example 1 herein. The formed catalyst configured as pieces of extrudate of lengths varying from about a millimeter to a about a centimeter and having a thickness of about 1/16 of an inch was dried and calcined prior to use. The formed catalyst (2 grams) was then charged to a flow reactor configured as in Examples 3-4. A test gas mixture containing varying amounts of ethanol as the organic reductant corresponding to a C1:N ratio of from about 4 to about 9, 25 parts per million NO, 7% by volume water, 12% by volume oxygen (O₂), the balance being nitrogen (N₂) was fed to the reactor. Total flow of the test gas stream was 1.5 standard liters per minute (SLPM). The product gas stream was monitored and the percent conversion of NO to nitrogen was determined. Data are gathered in Table 6 and show that the formed catalyst provided by the present invention is effective at NOx reduction.

TABLE 6
Example 5

| | | Organic | Temp. | | NO to N₂ |
|---|---|---|---|---|---|
| Entry | Catalyst | reductant | ° C. | C:N | Conversion |
| Example 5 | zeolite and silver | Ethanol | 400° C. | 4.1 | 36.5% |
| | on Al₂O₃ only | | | | |
| Example 5 | zeolite and silver | Ethanol | 400° C. | 7.0 | 44.4% |
| | on Al₂O₃ only | | | | |
| Example 5 | zeolite and silver | Ethanol | 400° C. | 9.0 | 51.3% |
| | on Al₂O₃ only | | | | |
| Example 5 | zeolite and silver | Ethanol | 425° C. | 4.3 | 42.1% |
| | on Al₂O₃ only | | | | |
| Example 5 | zeolite and silver | Ethanol | 425° C. | 5.8 | 48.6% |
| | on Al₂O₃ only | | | | |
| Example 5 | zeolite and silver | Ethanol | 425° C. | 8.6 | 58.2% |
| | on Al₂O₃ only | | | | |
| Example 5 | zeolite and silver | Ethanol | 450° C. | 4.4 | 46.0% |
| | on Al₂O₃ only | | | | |
| Example 5 | zeolite and silver | Ethanol | 450° C. | 6.6 | 55.6% |
| | on Al₂O₃ only | | | | |
| Example 5 | zeolite and silver | Ethanol | 450° C. | 8.6 | 64.9% |
| | on Al₂O₃ only | | | | |

All ranges disclosed herein are inclusive of the endpoints, and the endpoints are combinable with each other. The terms “first,” “second,” and the like as used herein do not denote any order, quantity, or importance, but rather are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A formed catalyst comprising:
a binder; and
a zeolite; and
a catalytic metal disposed upon a porous inorganic material;
wherein the zeolite is substantially free of the catalytic metal, and
wherein the formed catalyst is configured as an extrudate, pellet or foam.

2. The formed catalyst of claim 1, wherein the formed catalyst is configured as an extrudate.

3. The formed catalyst of claim 1, wherein the formed catalyst is configured as a foam.

4. The formed catalyst of claim 1, wherein the zeolite is zeolite Y, zeolite beta, ferrierite, mordenite, ZSM-5, or a combination comprising at least one of the foregoing zeolites.

5. The formed catalyst of claim 1, wherein the zeolite comprises ferrierite.

6. The formed catalyst of claim 5, wherein the ferrierite has silicon to aluminum molar ratio of 20.

7. The formed catalyst of claim 5, wherein the ferrierite has a surface area of about 200 to about 500 m²/gm.

8. The formed catalyst of claim 1, wherein the catalytic metal is silver, gold, palladium, cobalt, nickel, iron, gallium, indium, zirconium, copper, zinc or a combination comprising at least one of the foregoing metals.

9. The formed catalyst of claim 1, wherein the porous inorganic material is selected from the group consisting of inorganic oxides, inorganic carbides, inorganic nitrides, inorganic hydroxides, inorganic oxides having a hydroxide coating, inorganic carbonitrides, inorganic oxynitrides, inorganic borides, inorganic borocarbides, and combinations comprising at least one of the foregoing inorganic materials.

10. The formed catalyst of claim 1, wherein the porous inorganic material is selected from the group consisting of silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, and combinations comprising at least one of the foregoing.

11. The formed catalyst of claim 1, wherein the zeolite is present in an amount corresponding to from about 1 weight percent to about 40 weight percent, based upon a total weight of the formed catalyst.

12. The formed catalyst of claim 1, wherein the binder comprises boehmite, saw dust, methylcellulose, sugar or a combination thereof.

13. The formed catalyst of claim 1, wherein the catalyst is configured as an extrudate having a thickness in a range from about 1.0 mm to about 12 mm.

14. A method of making a formed catalyst, comprising:
combining a binder, a first catalyst composition comprising a zeolite, and a second catalyst composition comprising a catalytic metal disposed upon a porous inorganic material, to form an extrudable mixture wherein said zeolite is substantially free of the catalytic metal; and extruding said mixture to provide a formed catalyst configured as an extrudate.

15. The method of claim 14, further comprising:
drying and calcining the extrudate.

16. The method of claim 15, wherein said calcining comprises heating at a temperature in a range from about 400° C. to about 800° C.

17. The method of claim 14, wherein the zeolite is zeolite Y, zeolite beta, ferrierite, mordenite, ZSM-5, or a combination comprising at least one of the foregoing zeolites.

18. The method of claim 14, wherein the catalytic metal is silver, gold, palladium, cobalt, nickel, iron, or a combination comprising at least one of the foregoing metals.

19. The method of claim 14, wherein the porous inorganic material is silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, or combinations comprising at least one of the foregoing borides.

20. A method of making a formed catalyst, comprising:
combining a binder, a first catalyst composition comprising a zeolite, and a second catalyst composition comprising a catalytic metal disposed upon a porous inorganic material, and a solvent to form a slurry;
immersing a template in the slurry;
removing the template from the slurry to provide a treated template; and
calcining the treated template to provide a formed catalyst configured as a foam.

21. The method of claim 20, wherein said calcining comprising heating at a temperature in a range between about 200° C. and about 1100° C.

22. A method of reducing NOx comprising:
exposing an exhaust gas stream comprising NOx to a formed catalyst, the formed catalyst comprising a zeolite and a catalytic metal disposed upon a porous inorganic material;
wherein the zeolite is substantially free of the catalytic metal, and
wherein the formed catalyst is configured as an extrudate, pellet or foam.
wherein the catalyst in the form of an extrudate or foam.

23. The method of claim 23, wherein the zeolite is zeolite Y, zeolite beta, ferrierite, mordenite, ZSM-5, or a combination comprising at least one of the foregoing zeolites.

24. The method of claim 24, wherein the catalytic metal is silver, gold, palladium, cobalt, nickel, iron, gallium, indium, zirconium, copper, zinc, or a combination comprising at least one of the foregoing metals.
